(19) United States
(12) Patent Application Publication
(10) Pub. No.: US 2026/0359439 A1
(43) Pub. Date: Nov. 12, 2026

(54) METHOD, SERVER SYSTEM, AND COMPUTER-READABLE STORAGE MEDIUM FOR GENERATING REACTION-STRATEGY NETWORK FOR RED TEAMING

(71) Applicant: SELECT STAR, INC., Daejeon (KR)

(72) Inventors: BaRom Kang, Hwaseong-si (KR); Min Jae Jung, Bucheon-si (KR)

(73) Assignee: SELECT STAR, INC., Daejeon (KR)

(21) Appl. No.: 19/256,637

(22) Filed: Jul. 1, 2025

(30) Foreign Application Priority Data
May 8, 2025 (KR) 10-2025-0059567

(51) Int. Cl. G06F 21/56; G06F 16/3329

(52) U.S. Cl. CPC G06F 21/566; G06F 16/3329

(57) ABSTRACT

The present invention relates to a method, a system, and a computer-readable storage medium of generating a reaction-strategy network for red teaming, and more specifically, to a method, a system, and a computer-readable storage medium of generating a reaction-strategy network for red teaming so as to derive a reaction to an attack prompt through LLM, derive an evaluation score for the reaction, and then derive a strategy based on the evaluation score, thereby generating a reaction network subject to the reaction and a strategy network subject to the strategy.

### CROSS REFERENCE TO RELATED APPLICATION

The present application claims the right of priority to and the benefits of Korean Application No. 10-2025-0059567 having a filing date of May 8, 2025, the content of which is hereby incorporated by reference in its entirety.

### BACKGROUND OF THE INVENTION

### 1. Field of the Invention

The present invention relates to a method, a system, and a computer-readable storage medium of generating a reaction-strategy network for red teaming, and more specifically, to a method, a system, and a computer-readable storage medium of generating a reaction-strategy network for red teaming so as to derive a reaction to an attack prompt through LLM, derive an evaluation score for the reaction, and then derive a strategy based on the evaluation score, thereby generating a reaction network subject to the reaction and a strategy network subject to the strategy.

### 2. Description of the Related Art

Recently, large language models (LLMs) have greatly progressed. However, because incidents such as harmful information leakages due to large amounts of data learning or suicides due to excessive immersion of users are currently occurring, a hazard management on LLMs has become an essential factor. In order to manage potential harms inherent in LLMs, it is emerging as an important task of the present society to evaluate the harmfulness of a system from the perspective of an actual attacker by adopting the concept of Red Teaming originated in the military and security fields into LLM evaluations.

Accordingly, the LLM red teaming can test whether a model contains the potential harmfulness including sensitive information leakage, exploitability, bias and the like, and for this purpose, automatically generate attack prompts and derive evaluations on attacks or reactions. Recently, companies in the LLM field have made efforts to verify safety and reliability of LLMs by launching their developing LLMs after passing the red team test or by holding red team challenges.

Particularly, the automated attack prompt generation technique refers to a scheme of reversely taking advantage of the performance of recently developed LLMs to request attacks to the LLMs. The above technique is used to generate attack prompts several times, and then measure the score of each attack using LLMs to sample only good attacks, so that an attack success rate (ASR) may be increased.

In this situation, there is a need for a technology capable of applying the automated attack prompt generation technique to a graph theory to generate network data for generating attack prompts.

### SUMMARY OF THE INVENTION

An object of the present invention is to provide a method, a system, and a computer-readable storage medium of generating a reaction-strategy network for red teaming, and more specifically, to provide a method, a system, and a computer-readable storage medium of generating a reaction-strategy network for red teaming so as to derive a reaction to an attack prompt through LLM, derive an evaluation score for the reaction, and then derive a strategy based on the evaluation score, thereby generating a reaction network subject to the reaction and a strategy network subject to the strategy.

In order to solve the above problem, one embodiment of the present invention provides a method, which is performed on a server system including at least one processor and at least one memory, of generating a reaction-strategy network for red teaming, and the method includes: an attack prompt generation step of generating an attack prompt by inputting a seed including a generation request for the attack prompt into an attack prompt generation module; a reaction derivation step of deriving a reaction by inputting the attack prompt into a target LLM; an evaluation score derivation step of deriving an evaluation score for the reaction by inputting the corresponding reaction into an evaluation module; a strategy derivation step of selecting a strategy pair including two attack prompts, reactions and evaluation scores and having the different evaluation scores for a same seed, and inputting the seed, the first attack prompt, the second attack prompt, the first reaction, the second reaction, the first evaluation score, and the second evaluation score into a strategy derivation module to derive a strategy corresponding to the first attack prompt, in which the first attack prompt corresponds to an attack prompt having the evaluation score higher than the evaluation score of the second attack prompt; a library storage step of grouping the seed, the first attack prompt, the second attack prompt, the first reaction, the second reaction, a difference between the first evaluation score and the second evaluation score, and the strategy as one set to store the one set in a library of the server system; a reaction network generation step of generating a reaction network including a plurality of reaction nodes serving as nodes for the second reactions having the evaluation scores lower than the evaluation scores of the first reactions, respectively; and a strategy network generation step of generating a strategy network including a plurality of strategy nodes serving as nodes for the strategies, respectively.

In one embodiment of the present invention, the reaction network generation step may include deriving connection relationship information between the reaction nodes based on an embedding value of each of the second reactions, and then, deriving a reaction community for the reaction network based on the connection relationship information.

In one embodiment of the present invention, the method of generating the reaction-strategy network further includes: a community generation step of generating a reaction community for the reaction network and a strategy community for the strategy network, wherein the community generation step may include: a reaction community generation step of generating a first preset number of reaction communities based on connection relationship information between the reaction nodes included in the reaction network; a strategy community generation step of generating a second preset number of strategy communities based on the connection relationship information between the strategy nodes included in the strategy network; and a relationship index calculation step of calculating a relationship index for the second number of strategic communities from each of the first number of reaction communities.

In one embodiment of the present invention, the relationship index may be calculated based on the number of connection relationship information between the reaction nodes included in each of the reaction communities and the strategy nodes included in each of the strategy communities according to the connection relationship information between the reaction nodes and the strategy nodes.

In one embodiment of the present invention, the relationship index may be calculated based on a matching rate between a specific reaction community and a specific strategy community according to the connection relationship information between the reaction nodes and the strategy nodes, and based on the matching rate and a weight according to the evaluation score.

In order to solve the above-mentioned problem, one embodiment of the present invention provides a server system including at least one processor and at least one memory and performing a method of generating a reaction-strategy network for red teaming, and the server system includes: an attack prompt generation unit for generating an attack prompt by inputting a seed including a generation request for the attack prompt into an attack prompt generation module; a reaction derivation unit for deriving a reaction by inputting the attack prompt into a target LLM; an evaluation score derivation unit for deriving an evaluation score for the reaction by inputting the corresponding reaction into an evaluation module; a strategy derivation unit for selecting a strategy pair including two attack prompts, reactions and evaluation scores and having the different evaluation scores for a same seed, and inputting the seed, the first attack prompt, the second attack prompt, the first reaction, the second reaction, the first evaluation score, and the second evaluation score into a strategy derivation module to derive a strategy corresponding to the first attack prompt, in which the first attack prompt corresponds to an attack prompt having the evaluation score higher than the evaluation score of the second attack prompt; a library storage unit for grouping the seed, the first attack prompt, the second attack prompt, the first reaction, the second reaction, a difference between the first evaluation score and the second evaluation score, and the strategy as one set to store the one set in a library of the server system; a reaction network generation unit for generating a reaction network including a plurality of reaction nodes serving as nodes for the second reactions having the evaluation scores lower than the evaluation scores of the first reactions, respectively; and a strategy network generation unit for generating a strategy network including a plurality of strategy nodes serving as nodes for the strategies, respectively.

In order to solve the above problem, one embodiment of the present invention provides a computer-readable storage medium for implementing a method, which is performed on a server system including at least one processor and at least one memory, of generating a reaction-strategy network for red teaming, and the computer-readable storage medium includes computer-executable instructions for allowing the server system to perform the following steps including: an attack prompt generation step of generating an attack prompt by inputting a seed including a generation request for the attack prompt into an attack prompt generation module; a reaction derivation step of deriving a reaction by inputting the attack prompt into a target LLM; an evaluation score derivation step of deriving an evaluation score for the reaction by inputting the corresponding reaction into an evaluation module; a strategy derivation step of selecting a strategy pair including two attack prompts, reactions and evaluation scores and having the different evaluation scores for a same seed, and inputting the seed, the first attack prompt, the second attack prompt, the first reaction, the second reaction, the first evaluation score, and the second evaluation score into a strategy derivation module to derive a strategy corresponding to the first attack prompt, in which the first attack prompt corresponds to an attack prompt having the evaluation score higher than the evaluation score of the second attack prompt; a library storage step of grouping the seed, the first attack prompt, the second attack prompt, the first reaction, the second reaction, a difference between the first evaluation score and the second evaluation score, and the strategy as one set to store the one set in a library of the server system; a reaction network generation step of generating a reaction network including a plurality of reaction nodes serving as nodes for the second reactions having the evaluation scores lower than the evaluation scores of the first reactions, respectively; and a strategy network generation step of generating a strategy network including a plurality of strategy nodes serving as nodes for the strategies, respectively.

According to one embodiment of the present invention, the attack prompts for red teaming can be generated based on the reaction network and the strategy network.

According to one embodiment of the present invention, the attack prompts can be generated through LLM.

According to one embodiment of the present invention, the evaluation scores can be derived based on LLM's reactions to the attack prompts.

According to one embodiment of the present invention, the strategies corresponding to the attack prompts can be derived.

According to one embodiment of the present invention, the reaction network including multiple reaction nodes can be generated based on evaluation scores.

According to one embodiment of the present invention, the strategy network including multiple strategy nodes can be generated based on the strategy.

According to one embodiment of the present invention, the connection relationship information between the nodes can be derived based on the embedding values.

According to one embodiment of the present invention, the reaction community and the strategic community can be generated based on the connection relationship information.

According to one embodiment of the present invention, the relationship index between the reaction community and the strategy community can be calculated based on the connection relationship information between the reaction node and the strategy node.

### BRIEF DESCRIPTION OF THE DRAWINGS

FIG. 1 schematically shows the internal configuration of a server system according to one embodiment of the present invention.

FIG. 2 schematically shows execution processes of an attack prompt generation step, a reaction derivation step, and an evaluation score derivation step according to one embodiment of the present invention.

FIG. 3 schematically shows the execution process of the evaluation score derivation step according to one embodiment of the present invention.

FIG. 4 schematically shows the execution process of the strategy derivation step according to one embodiment of the present invention.

FIG. 5 schematically shows the execution process of a library storage step according to one embodiment of the present invention.

FIG. 6 schematically shows the execution process of a reaction network generation step according to one embodiment of the present invention.

FIG. 7 schematically shows the execution process of a strategic network generation step according to one embodiment of the present invention.

FIG. 8 schematically shows a connection relationship between a reaction network and a strategy network according to one embodiment of the present invention.

FIGS. 9A and 9B schematically show the execution process of a community generation step according to one embodiment of the present invention.

FIG. 10 schematically shows the execution process of the community generation step according to one embodiment of the present invention.

FIG. 11 schematically shows internal components of the computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

The “user terminal” referred to below may be implemented as a computer or portable terminal that can access a server or other terminals through a network. The computer may include, for example, a notebook computer, a desktop, a laptop, and the like installed with a web browser, and the portable terminal may include all kinds of handheld-based wireless communication device such as smartphone, personal communication system (PCS), global system for mobile communications (GSM), personal digital cellular (PDC), personal handyphone system (PHS), personal digital assistant (PDA), international mobile telecommunication (IMT)-2000, code division multiple access (CDMA)-2000, W-code division multiple access (W-CDMA), wireless broadband internet (Wibro), or bluetooth low energy (BLE) beacon terminal. In addition, “network” may be implemented by a wired network such as a local area network (LAN), a wide area network (WAN) or a value added network (VAN), and all types of wireless network such as a mobile radio communication network, or a satellite network.

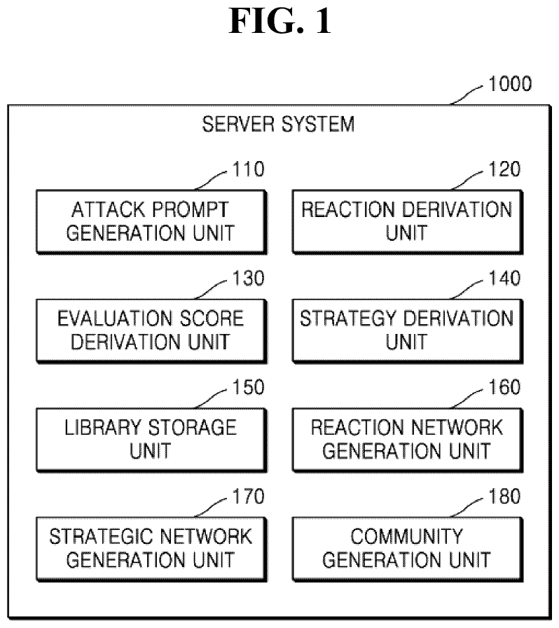

FIG. 1 schematically shows the internal configuration of a server system 1000 according to one embodiment of the present invention.

As shown in FIG. 1, the server system 1000 includes: an attack prompt generation unit 110 for executing an attack prompt generation step of generating an attack prompt by inputting a seed including a generation request for the attack prompt into an attack prompt generation module 1110; a reaction derivation unit 120 for executing a reaction derivation step of deriving a reaction by inputting the attack prompt into a target LLM 1120; an evaluation score derivation unit 130 for executing an evaluation score derivation step of deriving an evaluation score for the reaction by inputting the corresponding reaction into an evaluation module 1130; a strategy derivation unit 140 for executing a strategy derivation step of selecting a strategy pair including two attack prompts, reactions and evaluation scores and having the different evaluation scores for a same seed, and inputting the seed, the first attack prompt, the second attack prompt, the first reaction, the second reaction, the first evaluation score, and the second evaluation score into a strategy derivation module 1140 to derive a strategy corresponding to the first attack prompt, in which the first attack prompt corresponds to an attack prompt having the evaluation score higher than the evaluation score of the second attack prompt; a library storage unit 150 for executing a library storage step of grouping the seed, the first attack prompt, the second attack prompt, the first reaction, the second reaction, a difference between the first evaluation score and the second evaluation score, and the strategy as one set to store the one set in a library of the server system 1000; a reaction network generation unit 160 for executing a reaction network generation step of generating a reaction network including a plurality of reaction nodes serving as nodes for the second reactions having the evaluation scores lower than the evaluation scores of the first reactions, respectively; a strategy network generation unit 170 for executing a strategy network generation step of generating a strategy network including a plurality of strategy nodes serving as nodes for the strategies, respectively; and a community generation unit 180 for executing a community generation step of generating a reaction community for the reaction network and a strategy community for the strategy network.

Specifically, each component included in the server system 1000 shown in FIG. 1 serves to control operations of the server system 1000 for performing the method of generating the reaction-strategy network according to the present invention.

More specifically, the attack prompt generation unit 110 of the server system 1000 may generate an attack prompt by inputting a seed including a generation request for an attack prompt into the attack prompt generation module 1110.

In one embodiment of the present invention, the attack prompt generation module 1110 may be a module that includes an LLM and generates an attack prompt through the LLM when a seed is input, or may be a module that generates an attack prompt by generating a seed and inputting a prompt including the seed and a generation request for an attack prompt into an LLM outside the attack prompt generation module 1110, or may be a module that generates an attack prompt, when a seed is input, by inputting a prompt including the seed and a request for generation of an attack prompt into an LLM outside the attack prompt generation module 1110.

The reaction derivation unit 120 of the server system 1000 may derive a reaction by inputting the attack prompt into the target LLM 1120.

In one embodiment of the present invention, the target LLM 1120 may be an LLM located outside or inside the server system 1000, and may be a model that derives a reaction including an answer to an attack prompt when the attack prompt is input.

The evaluation score derivation unit 130 of the above server system 1000 may input the reaction into the evaluation module 1130 to derive an evaluation score for the corresponding reaction.

In one embodiment of the present invention, the evaluation module 1130 may be a module that includes an LLM and derives an evaluation score for a specific reaction through the LLM when the specific reaction is input, or may be a module that, when a specific reaction is input, inputs a prompt including the specific reaction and a request for deriving an evaluation score for the specific reaction into an LLM outside the evaluation module 1130 to derive the evaluation score for the specific reaction.

The strategy derivation unit 140 of the server system 1000 may select a strategy pair including two attack prompts, reactions and evaluation scores and having the different evaluation scores for a same seed, and input the seed, the first attack prompt, the second attack prompt, the first reaction, the second reaction, the first evaluation score, and the second evaluation score into a strategy derivation module 1140 to derive a strategy corresponding to the first attack prompt, in which the first attack prompt may correspond to an attack prompt having the evaluation score higher than the evaluation score of the second attack prompt.

The strategy may include a plurality of strategies including role-playing strategies and storytelling strategies so as to attack the LLM.

In one embodiment of the present invention, the strategy derivation module 1140 may be a module that includes an LLM and derives a strategy corresponding to a first attack prompt having an evaluation score higher than that of the second attack prompt through the LLM when a seed, the first attack prompt, the second attack prompt, a first reaction, a second reaction, a first evaluation score, and a second evaluation score are input, or may be a module that derives a strategy corresponding to a first attack prompt, when a seed, the first attack prompt, a second attack prompt, a first reaction, a second reaction, a first evaluation score, and a second evaluation score are input, by inputting a prompt including a strategy derivation request corresponding to the first attack prompt having an evaluation score higher than that of the second attack prompt into an LLM outside the strategy derivation module 1140.

The library storage unit 150 of the server system 1000 may group the seed, the first attack prompt, the second attack prompt, the first reaction, the second reaction, a difference between the first evaluation score and the second evaluation score, and the strategy as one set to store the one set in a library of the server system 1000.

In one embodiment of the present invention, the library may store a plurality of sets including a seed, a first attack prompt, a second attack prompt, a first reaction, a second reaction, a difference between a first evaluation score and a second evaluation score, and a strategy, and a reaction network, a strategy network, a reaction community, and a strategy community for red teaming may be generated based on the sets included in the library.

The reaction network generation unit 160 of the server system 1000 may generate a reaction network including a plurality of reaction nodes having second reactions as nodes, respectively, with respect to the second reaction having the evaluation score lower than that of the first reaction.

In one embodiment of the present invention, the reaction network generation step may include deriving connection relationship information between the reaction nodes based on embedding values of the second reactions, respectively, and then deriving a reaction community for the reaction network based on the connection relationship information.

The strategy network generation unit 170 of the server system 1000 may generate a strategy network including a plurality of strategy nodes having the strategies as nodes, respectively.

In one embodiment of the present invention, the strategic network generation step may include deriving connection relationship information between the strategy nodes based on the embedding value of each of the strategies, and then, deriving a strategy community for the strategy network based on the connection relationship information.

The community generation unit 180 of the server system 1000 may generate a reaction community for the reaction network and a strategic community for the strategic network.

In one embodiment of the present invention, the community generation step may include: a reaction community generation step of generating a first preset number of reaction communities based on connection relationship information between the reaction nodes included in the reaction network; a strategy community generation step of generating a second preset number of strategy communities based on the connection relationship information between the strategy nodes included in the strategy network; and a relationship index calculation step of calculating a relationship index for the second number of strategic communities from each of the first number of reaction communities.

The relationship index may be calculated based on the number of connection relationship information between the reaction nodes included in each of the reaction communities and the strategy nodes included in each of the strategy communities according to the connection relationship information between the reaction nodes and the strategy nodes. Alternatively, the relationship index may be calculated based on a matching rate between a specific reaction community and a specific strategy community according to the connection relationship information between the reaction nodes and the strategy nodes, and based on a weight according to the evaluation score.

Preferably, the red teaming refers to a security evaluation scheme for identifying security vulnerabilities and performing simulation as an actual attacker to tests a security defense system, and may provide comprehensive and realistic attack scenarios, test a model to be evaluated for the ability to respond to actual cyber-attack situations, and check a security status of an organization by using various attack techniques in the attacker's perspective. The main purpose of the red teaming is to check a defense system of the organization and discover security vulnerabilities to allow the organization to supplement the security vulnerabilities. For example, a model to be evaluated may be evaluated by inputting an attack prompt into the model and then evaluating a derived reaction.

The attack prompt refers to a prompt for inducing an answer containing an unethical factor or illegal factor, and the attack prompt may be input into an LLM to induce results deviated from the original purpose of the LLM, thereby evaluating the LLM.

Particularly, the attack prompt may include information such as a target system to be attacked, a strategy, a scenario for achieving the target, and a simulation condition. The strategy of the attack prompt may include information about which vulnerability of the LLM to exploit or which attack technique to use; the scenario for achieving the target may include information about tasks to do for achieving the target, such as privilege escalation, information capture, and service denial; and the simulation condition may include information about how to proceed with the attack and how to set the test environment conditions.

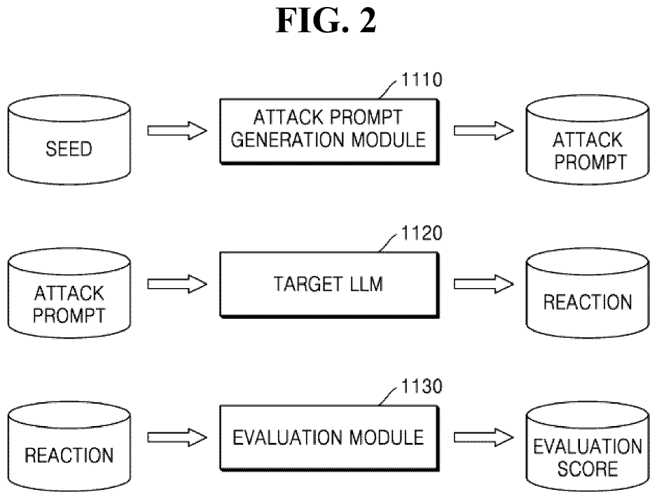

FIG. 2 schematically shows execution processes of an attack prompt generation step, a reaction derivation step, and an evaluation score derivation step according to one embodiment of the present invention.

Schematically, FIG. 2A shows the process of performing the attack prompt generation step; FIG. 2B shows the process of performing the reaction derivation step; and FIG. 2C shows the process of performing the evaluation score derivation step.

Specifically, the attack prompt generation step may include generating an attack prompt by inputting a seed including a generation request for the attack prompt into the attack prompt generation module 1110, the reaction derivation step may include deriving a reaction by inputting the attack prompt into the target LLM 1120, and the evaluation score derivation step may include deriving an evaluation score for the reaction by inputting the corresponding reaction into the evaluation module 1130.

As shown in FIG. 2A, an attack prompt may be generated by inputting a seed including a generation request for an attack prompt into the attack prompt generation module 1110. In one embodiment of the present invention, the seed may include an example of the attack prompt, and a generation request for the attack prompt.

Preferably, the attack prompt refers to a prompt for inducing an answer containing a preset unethical or illegal factor. When the attack prompt is input into the LLM-based system and the LLM-based system derives an answer including the unethical or illegal factor, it can be said that the attack on the LLM-based system succeeds. When the LLM-based system derives an answer that does not contain the unethical or illegal factor, it can be said that the attack on the LLM-based system fails.

Accordingly, the attack prompt may include a prompt including a question for inducing the LLM-based system to derive a specific answer, and the attack here may be a technique for inducing the LLM-based system to produce results deviated from the original purpose of artificial intelligence.

As shown in FIG. 2B, a reaction may be derived by inputting the attack prompt into the target LLM 1120, and the reaction may include all answers of the target LLM 1120 with respect to the corresponding attack prompt.

When the reaction contains the answer induced by the corresponding attack prompt, the attack prompt may be determined as a successful attack, and when the reaction does not contain the answer induced by the corresponding attack prompt, the attack prompt may be determined as a failed attack. Thereafter, the attack prompt having succeeded in attack may receive a higher evaluation score than the attack prompt having failed in attack.

As shown in FIG. 2C, the reaction may be input into the evaluation module 1130 to derive an evaluation score for the reaction, the attack prompt having induced the corresponding reaction may be evaluated as a successful attack prompt when the evaluation score is higher, and strategies for attack prompts having high evaluation scores may be derived thereafter.

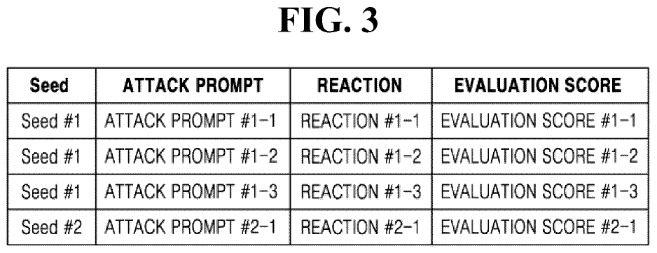

FIG. 3 schematically shows the execution process of the evaluation score derivation step according to one embodiment of the present invention.

Schematically, the evaluation score derivation step may include deriving an evaluation score for the reaction by inputting the corresponding reaction into the evaluation module 1130.

Specifically, the evaluation module 1130 may derive an evaluation score for the reaction derived from the target LLM 1120, and derive evaluation scores for reactions to attack prompts, respectively, so that the evaluation may be performed for the corresponding attack prompt.

As shown in FIG. 3, in the case that a seed including seed #1 and seed #2 is present, attack prompt #1-1 to attack prompt #1-3 may be generated, respectively, when seed #1 is input into the attack prompt generation module 1110, and attack prompt #2-1 may be derived when seed #2 is input into the attack prompt generation module 1110. In one embodiment of the present invention, a plurality of attack prompts may be generated based on one seed.

When attack prompt #1-1 to attack prompt #1-3 are input into the target LLM 1120, reaction #1-1 to attack prompt #1-1 may be derived, reaction #1-2 to attack prompt #1-2 may be derived, and reaction #1-3 to attack prompt #1-3 may be derived, and when attack prompt #2-1 is input into the target LLM 1120, reaction #2-1 to attack prompt #2-1 may be derived.

When the reactions are input into the evaluation module 1130, evaluation score #1-1 for reaction #1-1 may be derived, evaluation score #1-2 for reaction #1-2 may be derived, evaluation score #1-3 for reaction #1-3 may be derived, and evaluation score #2-1 for reaction #2-1 may be derived. Evaluation scores for a plurality of reactions to one seed may be derived to be the same as each other or different from each other. Preferably, the evaluation scores may correspond to evaluation scores for attack prompts and reactions, and the evaluation score may be derived to be higher when the attack prompt is more aggressive.

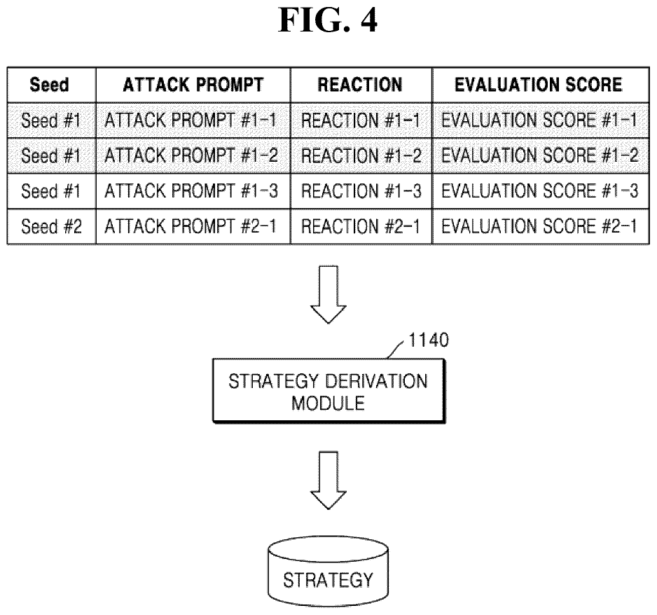

FIG. 4 schematically shows the execution process of the strategy derivation step according to one embodiment of the present invention.

Schematically, the strategy derivation step may include selecting a strategy pair including two attack prompts, reactions and evaluation scores and having the different evaluation scores for a same seed, and inputting the seed, the first attack prompt, the second attack prompt, the first reaction, the second reaction, the first evaluation score, and the second evaluation score into a strategy derivation module 1140 to derive a strategy corresponding to the first attack prompt.

The first attack prompt may correspond to the attack prompt having a higher evaluation score than the second attack prompt, and the first reaction may correspond to a reaction having a higher evaluation score than the second reaction.

Specifically, the strategy pair may include a first attack prompt, a second attack prompt, a first reaction, a second reaction, a first evaluation score, and a second evaluation score, and the first attack prompt and the second attack prompt may correspond to different attack prompts derived for the same seed.

As shown in FIG. 4, when evaluation score #1-1 and evaluation score #1-2 are different scores, and evaluation score #1-2 and evaluation score #1-3 are the same score, one strategy pair may be selected to include attack prompts #1-1 and #1-2, reactions #1-1 and #1-2, and evaluation scores #1-1 and #1-2 for evaluation scores #1-1 and #1-2.

When evaluation score #1-1 is a higher score than evaluation score #1-2, a strategy corresponding to attack prompt #1-1 may be derived by inputting seed #1, attack prompt #1-1, attack prompt #1-2, reaction #1-1, reaction #1-2, evaluation score #1-1, and evaluation score #1-2 into the strategy derivation module 1140.

In one embodiment of the present invention, the above strategy may include a factor or a reason why attack prompt #1-1 has received the higher evaluation score than attack prompt #1-2, or may include a reason why attack prompt #1-1 has succeeded in attack.

Preferably, because evaluation score #1-2 and evaluation score #1-3 are the same score, attack prompt #1-2 and attack prompt #1-3 are not allowed to be selected as a single strategic pair. Because evaluation score #1-1 and #evaluation score 2-1 are evaluation scores corresponding to attack prompts derived from different seeds, attack prompt #1-1 and attack prompt #2-1 are not allowed to be selected as a single strategic pair.

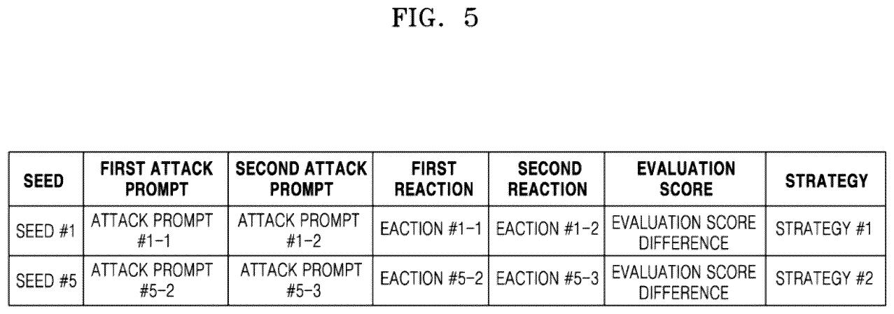

FIG. 5 schematically shows the execution process of a library storage step according to one embodiment of the present invention.

Schematically, the library storage step may include grouping the seed, the first attack prompt, the second attack prompt, the first reaction, the second reaction, the difference between the first evaluation score and the second evaluation score, and the strategy as one set to store the one set in the library of the server system 1000.

Preferably, when a new red teaming is performed or a new attack prompt is generated, data stored in the library of the server system 1000 may be referred.

Referring to FIG. 4, when one strategy pair including attack prompt #1-1, attack prompt #1-2, reaction #1-1, reaction #1-2, evaluation score #1-1, and evaluation score #1-2 is selected, and seed #1, attack prompt #1-1, attack prompt #1-2, reaction #1-1, reaction #1-2, evaluation score #1-1, and evaluation score #1-2 are input into the strategy derivation module 1140 to derive a strategy corresponding to the attack prompt #1-1, seed #1, attack prompt #1-1, attack prompt #1-2, reaction #1-1, reaction #1-2, the difference between evaluation score #1-1 and evaluation score #1-2, the strategy may be grouped as one set and stored in the library.

Preferably, when the evaluation score #1-1 is higher than the evaluation score #1-2, attack prompt #1-1 may correspond to the first attack prompt, attack prompt #1-2 may correspond to the second attack prompt, reaction #1-1 may correspond to the first reaction, reaction #1-2 may correspond to the second reaction, evaluation score #1-1 may correspond to the first evaluation score, and evaluation scores #1-2 may correspond to the second evaluation score.

As shown in FIG. 5, seed #1, attack prompt #1-1, attack prompt #1-2, reaction #1-1, reaction #1-2, a difference between evaluation scores #1-1 and #1-2, and strategy #1 may be stored as one set in the library, and seed #5, attack prompt #5-2, attack prompt #5-3,reaction #5-2, reaction #5-3, a difference between evaluation scores #5-2 and score #5-3, and strategy #2 may be stored as one set in the library.

The library may store the difference between the first evaluation score and the second evaluation score, may separately store the first evaluation score and the second evaluation score, and may store all of the first evaluation score, the second evaluation score, and the difference between the first and second evaluation scores.

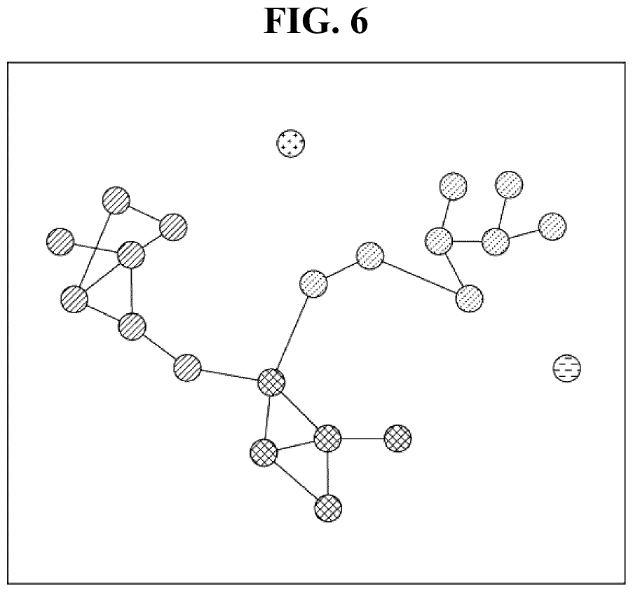

FIG. 6 schematically shows the execution process of a reaction network generation step according to one embodiment of the present invention.

Schematically, the reaction network generation step may include generating a reaction network including a plurality of reaction nodes serving as nodes for the second reactions having the evaluation scores lower than the evaluation scores of the first reactions, respectively.

Specifically, a plurality of reaction nodes may be generated such that the second reaction among the sets for the seed, the first attack prompt, the second attack prompt, the first reaction, the second reaction, the difference between the first and second evaluation scores, and the strategy stored in the library is set as one node. In other words, one reaction node may include one second reaction, and each of a plurality of reaction nodes may include second reactions different from each other, respectively.

In addition, connection relationship information between the reaction nodes may be derived based on the embedding value of each of the second reactions, and a reaction network including the reaction nodes and connection relationship information between the reaction nodes may be generated.

In one embodiment of the present invention, similarity between two reaction nodes among the reaction nodes may be calculated based on the embedding value of each of the second reactions, and connection relationship information between the two reaction nodes may be derived when the similarity is higher than a preset first reference.

As shown in FIG. 6, a reaction network including a plurality of reaction nodes may be generated, and FIG. 6 shows one reaction network. Each node shown in FIG. 6 corresponds to a reaction node, and the connection relationship information between reaction nodes may be indicated by straight lines connected between the reaction nodes.

In one embodiment of the present invention, depending on the embedding value of the second reaction or the reaction node, a specific reaction node that does not have connection relationship information with other reaction nodes may be present in the reaction network, a specific reaction node that has connection relationship information with one other reaction node may be present, and a specific reaction node that has connection relationship information with multiple reaction nodes may be present.

In addition, a color of each reaction node within the reaction network may be determined based on an embedding value of the reaction node or an embedding value of a second reaction corresponding to the reaction node. Reaction nodes having the same color may be similar reaction nodes based on embedding values.

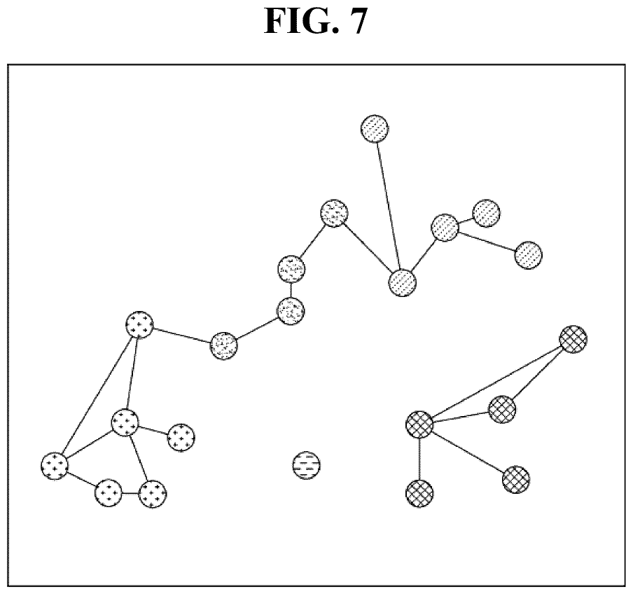

FIG. 7 schematically shows the execution process of a strategic network generation step according to one embodiment of the present invention.

Schematically, the strategic network generation step may include generating a strategy network including a plurality of strategy nodes having the strategies as nodes, respectively.

Specifically, among the sets for the seed, the first attack prompt, the second attack prompt, the first reaction, the second reaction, the difference between the first and second evaluation scores, and the strategy stored in the library, a plurality of strategy nodes having one node for each of the strategies may be generated. In other words, one strategy node may include one strategy, and a plurality of strategy nodes may include strategies different from each other, respectively, or may include the same strategy.

In addition, connection relationship information between the strategy nodes may be derived based on the embedding value of each of the strategies, and a strategy network including the strategy nodes and connection relationship information between the strategy nodes may be generated.

In one embodiment of the present invention, similarity between two strategy nodes among the strategy nodes may be calculated based on the embedding value of each of the strategies, and connection relationship information between the two strategy nodes may be derived when the similarity is higher than a preset second reference.

As shown in FIG. 7, a strategy network including a plurality of strategy nodes may be generated, and FIG. 7 shows one strategy network. Each node shown in FIG. 7 corresponds to a strategy node, and the connection relationship information between strategy nodes may be indicated by straight lines connected between the strategy nodes.

In one embodiment of the present invention, depending on the embedding value of the strategy or the strategy node, a specific strategy node that does not have connection relationship information with other strategy nodes may be present in the strategy network, a specific strategy node that has connection relationship information with one other strategy node may be present, and a specific strategy node that has connection relationship information with multiple strategy nodes may be present.

In addition, a color of each strategy node within the strategy network may be determined based on an embedding value of the strategy node or an embedding value of a strategy corresponding to the strategy node. Strategy nodes having the same color may be similar strategy nodes based on embedding values.

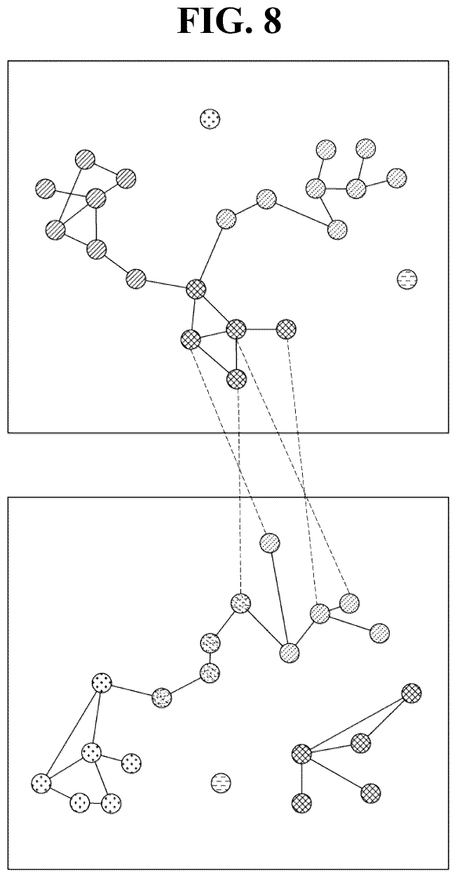

FIG. 8 schematically shows a connection relationship between a reaction network and a strategy network according to one embodiment of the present invention.

Schematically, the upper part of FIG. 8 shows a reaction network, and the lower part of FIG. 8 shows a strategy network.

Specifically, connection relationship information between the reaction nodes and the strategy nodes may be derived. Connection relationship information between a reaction node and a strategy node may be derived based on an embedding value of each of reaction nodes and an embedding value of each of strategy nodes. In one embodiment of the present invention, similarity between the reaction node and the strategy node may be calculated based on the embedding value of each of the reaction nodes and the embedding value of each of the strategy nodes, and connection relationship information between the reaction node and the strategy node may be derived when the similarity is higher than a preset third reference.

As shown in FIG. 8, the reaction nodes included in the reaction network shown in the upper part of FIG. 8 and the strategy nodes included in the strategy network shown in the lower part of FIG. 8 may have connection relationship information between each other.

Preferably, connection relationship information between other reaction nodes and strategy nodes may be provided in addition to the connection relationship information shown in FIG. 8. Reaction nodes that have connection relationship information with strategic nodes and reaction nodes that do not have connection relationship information with strategic nodes may be present among the reaction nodes, and strategy nodes that have connection relationship information with reaction nodes and strategy nodes that do not have connection relationship information with reaction nodes may be present among the strategy nodes.

In one embodiment of the present invention, the community generation step may include a node matching step of deriving connection relationship information between the reaction node and the strategy node.

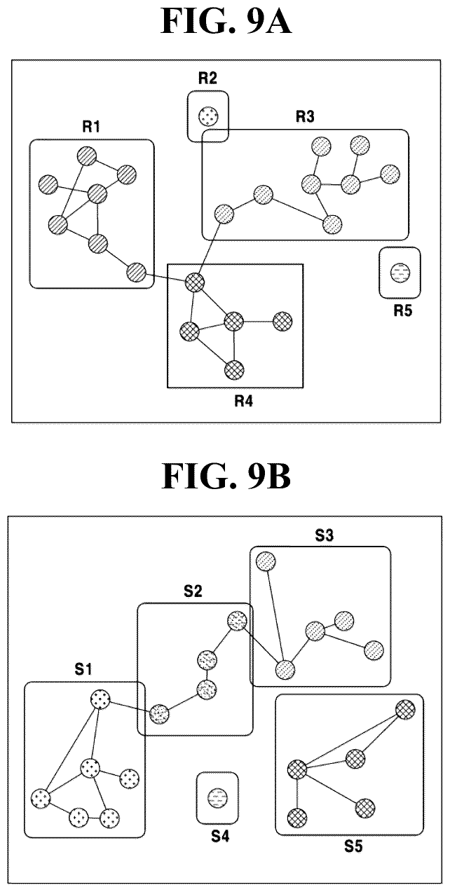

FIGS. 9A and 9B schematically show the execution process of a community generation step according to one embodiment of the present invention.

Schematically, FIG. 9A shows a reaction community, and FIG. 9B shows a strategy community.

Specifically, the community generation step may include: a reaction community generation step of generating a reaction community for the reaction network and a strategy community for the strategy network, and generating a first preset number of reaction communities based on the connection relationship information between the reaction nodes included in the reaction network; a strategy community generation step of generating a second preset number of strategy communities based on the connection relationship information between the strategy nodes included in the strategy network; and a relationship index calculation step of calculating a relationship index for the second number of strategic communities from each of the first number of reaction communities.

The relationship index may be calculated based on the number of connection relationship information between the reaction nodes included in each of the reaction communities and the strategy nodes included in each of the strategy communities according to the connection relationship information between the reaction nodes and the strategy nodes, or may be calculated based on a matching rate between a specific reaction community and a specific strategy community according to the connection relationship information between the reaction nodes and the strategy nodes, and based on the matching rate and a weight according to the evaluation score.

As shown in FIG. 9A, five reaction communities including R1 to R5 may be generated based on the connection relationship information between reaction nodes in the reaction network. The reaction network may include one or more reaction communities, and one reaction community may include one or more reaction nodes.

In one embodiment of the present invention, one single reaction community may include one or more reaction nodes similar to each other, and each of the reaction nodes may have connection relationship information for a strategy node.

As shown in FIG. 9B five strategic communities including S1 to S5 may be generated based on the connection relationship information between strategic nodes in the strategy network. The strategic network may include one or more strategic communities, and one strategy community may include one or more strategy nodes.

In one embodiment of the present invention, one strategy community may include one or more strategy nodes similar to each other, and each of the strategy nodes may have connection relationship information for a reaction node.

In one embodiment of the present invention, the reaction community and the strategy community may be structurally generated based on a Leiden algorithm. Preferably, when nodes and connection relationship information are present, regardless of similarity or embedding value, the communities may be generated based on the Leiden algorithm.

The Leiden algorithm refers to an algorithm used in network analysis and graph analysis to solve the community detection problem in the network analysis, and the Leiden algorithm is an improved scheme of the existing Louvain algorithm for optimizing modularity, and is designed to discover community structures more accurately and efficiently.

Each of the communities may include identification information including a community index. For example, when five reaction communities are present in the reaction network as shown in FIG. 9A, a community index for the first reaction community may correspond to [1 0 0 0 0], a community index for the second reaction community may correspond to [0 1 0 0 0], and a community index for the fifth reaction community may correspond to [0 0 0 0 1].

Accordingly, each of the reaction nodes may include information about the community index for the reaction community in which the reaction node is included. When a specific reaction node is included in the third reaction community among the five reaction communities, the community index for the specific reaction node may correspond to [0 0 1 0 0]. The community index may be generated based on a total number of communities included in the corresponding network and a sequence or number of the communities, and all of one or more nodes included in the same community may have the same community index.

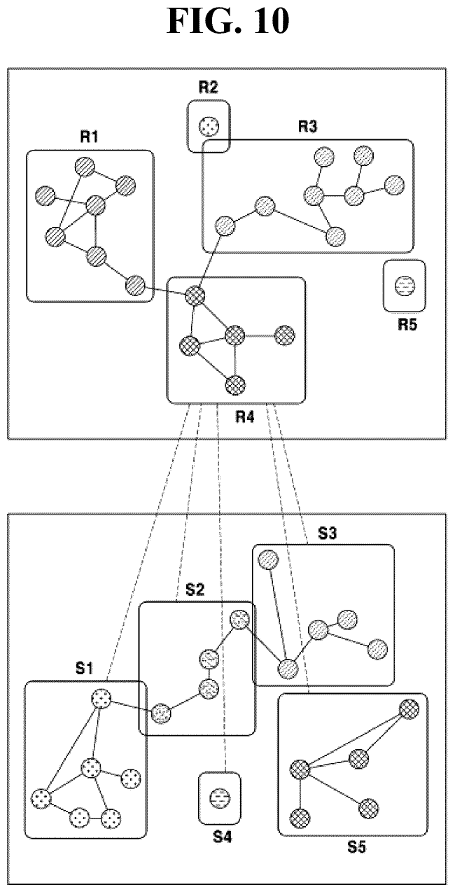

FIG. 10 schematically shows the execution process of the community generation step according to one embodiment of the present invention.

Schematically, the upper part of FIG. 10 shows a reaction community, and the lower part of FIG. 10 shows a strategy community.

Specifically, the community generation step may include calculating relationship indices for one or more strategic communities from one or more reaction communities.

As shown in FIG. 10, relationship indices may be calculated between reaction communities including R1 to R5 and strategy communities including S1 to S5. Accordingly, the relationship index between R1 and S1, the relationship index between R1 and S2, the relationship index between R1 and S3, . . . , the relationship index between R5 and S3, the relationship index between R5 and S4, and the relationship index between R5 and S5 may be calculated.

For example, relationship indices for R4 with S1, S2, S3, S4, and S5 may be calculated, respectively, and the relationship index between R4 and S1 may be calculated based on the number of connection relationship information between reaction nodes included in R4 and strategy nodes included in S1.

Referring to FIG. 8, the reaction node included in R4 may have connection relationship information with one strategy node included in S2, and the reaction node included in R4 may have connection relationship information with three strategy nodes included in S3. Accordingly, because the number of connection relationship information between R4 and S3 is greater than the number of connection relationship information between R4 and S2, the relationship index between R4 and S3 may be calculated to be higher than the relationship index between R4 and S2.

In one embodiment of the present invention, the relationship index may be calculated based on a matching rate between a specific reaction community and a specific strategy community according to the connection relationship information between the reaction nodes and the strategy nodes, and based on a weight according to the evaluation score.

Regarding the reaction node and the strategy node connected to each other, the relationship index may be calculated based on an evaluation score difference between the second evaluation score for the reaction node and the first evaluation score for the strategy node, and based on the sum of the evaluation score differences for nodes connected from corresponding reaction communities to corresponding strategy communities.

For example, a matching rate between the reaction community corresponding to R4 and each strategy community corresponding to S1 to S5 is calculated according to the connection relationship information between the reaction node and the strategy node, and the relationship indices may be calculated based on the matching rates and weights according to the evaluation scores for R4 and S1 to S5, respectively.

Referring to FIG. 8, when R4 and S3 have connection relationship information with each other, a difference between the evaluation score corresponding to R4 and the evaluation score corresponding to S3 may be calculated, and the relationship index between R4 and S3 may be calculated based on the sum of the evaluation score differences for the three nodes connected from R4 to S3.

According to the method of generating the reaction-strategy network of the present invention, the reaction network and the strategic network may be generated to upgrade the attack prompts for red teaming, and the attack prompts including strategies for successful red teaming may be generated based on the reaction network and the strategy network.

Accordingly, a target prompt may be generated by inputting a seed containing a request to generate an attack prompt into the target prompt generation module, a target reaction derivation step of inputting the target prompt into the target LLM to derive a target reaction may be performed, and then a target evaluation score for the target reaction may be derived by inputting the target reaction into the target evaluation module.

When the target evaluation score is equal to or lower than a preset reference, a reaction community to which a reaction node having the highest similarity to the target reaction belongs may be detected in a preset reaction network, a strategic community having the highest relationship index with the reaction community may be detected in a preset strategic network, a representative strategy corresponding to a representative strategy node belonging to the detected strategy community may be extracted, and a modification prompt may be generated by inputting the representative strategy and prompt modification information including the seed into the target prompt generation module.

Preferably, the reaction network may include a plurality reaction nodes having nodes for reactions derived when attack prompts input to the LLM, respectively, connection relationship information between the reaction nodes, and a reaction community based on the connection relationship information, and the strategy network may include a plurality of strategy nodes having nodes for strategies corresponding to the attack prompts derived from the LLM, respectively, connection relationship information between the reaction nodes, and a strategy community based on the connection relationship information.

In one embodiment of the present invention, the target prompt generation module may be a module that includes an LLM to generate a target prompt through the LLM when a seed is input, or may be a module that generates a target prompt by generating a seed and inputting a prompt including the seed and a generation request for an attack prompt into an LLM outside the target prompt generation module, or may be a module that generates a target prompt, when a seed is input, by inputting a prompt including the seed and a request for generation of an attack prompt into an LLM outside the target prompt generation module.

The target LLM corresponds to the LLM located outside or inside the server system 1000, and may be a model that derives a reaction including an answer to a target prompt when the target prompt is input.

The target evaluation module may be a module that includes an LLM and derives a target evaluation score for a specific target reaction through the LLM when the specific target reaction is input, or may be a module that, when a specific target reaction is input, inputs a prompt including the specific target reaction and a request for deriving a target evaluation score for the specific reaction into the LLM outside the target evaluation module to derive the target evaluation score for the specific target reaction.

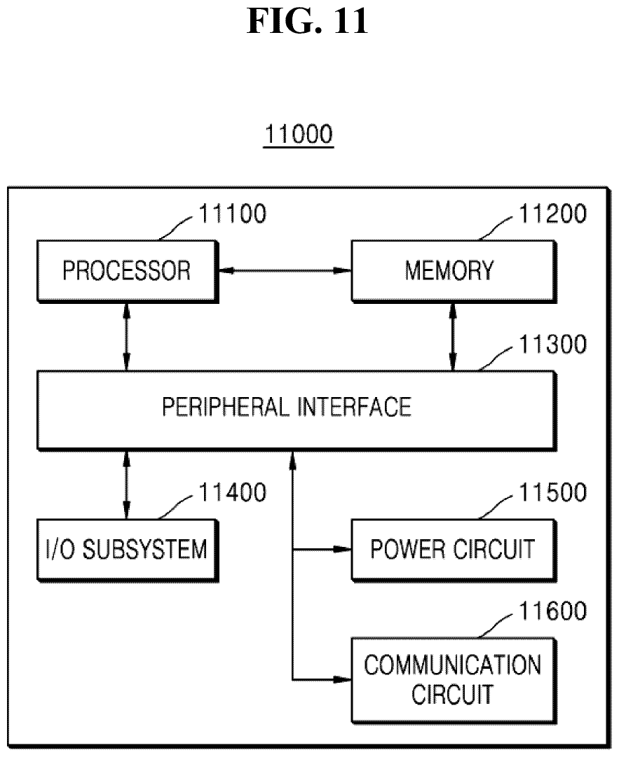

FIG. 11 schematically shows internal components of the computing device according to one embodiment of the present invention.

The server system 1000 shown in the above-described FIG. 1 may include components of the computing device 11000 shown in FIG. 11.

As shown in FIG. 11, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 11 is merely an example of the computing device 11000, and the computing device 11000 may have a configuration or arrangement in which some components shown in FIG. 11 are omitted, additional components not shown in FIG. 11 are further provided, or at least two components are combined. For example, a computing device for a communication terminal in a mobile environment may further include a touch screen, a sensor or the like in addition to the components shown in FIG. 11, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vice versa.

According to one embodiment of the present invention, the attack prompts for red teaming can be generated based on the reaction network and the strategy network.

According to one embodiment of the present invention, the attack prompts can be generated through LLM.

According to one embodiment of the present invention, the evaluation scores can be derived based on LLM's reactions to the attack prompts.

According to one embodiment of the present invention, the strategies corresponding to the attack prompts can be derived.

According to one embodiment of the present invention, the reaction network including multiple reaction nodes can be generated based on evaluation scores.

According to one embodiment of the present invention, the strategy network including multiple strategy nodes can be generated based on the strategy.

According to one embodiment of the present invention, the connection relationship information between the nodes can be derived based on the embedding values.

According to one embodiment of the present invention, the reaction community and the strategic community can be generated based on the connection relationship information.

According to one embodiment of the present invention, the relationship index between the reaction community and the strategy community can be calculated based on the connection relationship information between the reaction node and the strategy node.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method, which is performed on a server system including at least one processor and at least one memory, for generating a reaction-strategy network for red teaming, the method comprising:
an attack prompt generation step of generating an attack prompt by inputting a seed including a generation request for the attack prompt into an attack prompt generation module;
a reaction derivation step of deriving a reaction by inputting the attack prompt into a target LLM;
an evaluation score derivation step of deriving an evaluation score for the reaction by inputting the corresponding reaction into an evaluation module;
a strategy derivation step of selecting a strategy pair including first and second attack prompts, first and second reactions, and first and second evaluation scores and having the different evaluation scores for the same seed, and inputting the seed, the first attack prompt, the second attack prompt, the first reaction, the second reaction, the first evaluation score, and the second evaluation score into a strategy derivation module to derive a strategy corresponding to the first attack prompt, in which the first attack prompt corresponds to an attack prompt having the evaluation score higher than the evaluation score of the second attack prompt;
a library storage step of grouping the seed, the first attack prompt, the second attack prompt, the first reaction, the second reaction, a difference between the first evaluation score and the second evaluation score, and the strategy as one set to store the one set in a library of the server system;
a reaction network generation step of generating a reaction network including a plurality of reaction nodes serving as nodes for the second reactions having the evaluation scores lower than the evaluation scores of the first reactions, respectively; and
a strategy network generation step of generating a strategy network including a plurality of strategy nodes serving as nodes for the strategies, respectively.

2. The method of claim 1, wherein the reaction network generation step includes:
deriving connection relationship information between the reaction nodes based on an embedding value of each of the second reactions, and then,
deriving a reaction community for the reaction network based on the connection relationship information.

3. The method of claim 1, further comprising a community generation step of generating a reaction community for the reaction network and a strategy community for the strategy network,
wherein the community generation step includes:
a reaction community generation step of generating a first preset number of reaction communities based on connection relationship information between the reaction nodes included in the reaction network;
a strategy community generation step of generating a second preset number of strategy communities based on the connection relationship information between the strategy nodes included in the strategy network; and
a relationship index calculation step of calculating a relationship index for the second preset number of strategic communities from each of the first preset number of reaction communities.

4. The method of claim 3, wherein the relationship index is calculated based on a number of connection relationship information between the reaction nodes included in each of the reaction communities and the strategy nodes included in each of the strategy communities according to the connection relationship information between the reaction nodes and the strategy nodes.

5. The method of claim 3, wherein the relationship index is calculated based on a matching rate between a specific reaction community and a specific strategy community according to the connection relationship information between the reaction nodes and the strategy nodes, and based on a weight according to the evaluation score.

6. A server system including at least one processor and at least one memory and performing a method for generating a reaction-strategy network for red teaming, the server system comprising:
an attack prompt generation unit configured to generate an attack prompt by inputting a seed including a generation request for the attack prompt into an attack prompt generation module;
a reaction derivation unit configured to derive a reaction by inputting the attack prompt into a target LLM;
an evaluation score derivation unit configured to derive an evaluation score for the reaction by inputting the corresponding reaction into an evaluation module;
a strategy derivation unit configured to select a strategy pair including first and second attack prompts, first and second reactions, and first and second evaluation scores and having the different evaluation scores for the same seed, and configured to input the seed, the first attack prompt, the second attack prompt, the first reaction, the second reaction, the first evaluation score, and the second evaluation score into a strategy derivation module to derive a strategy corresponding to the first attack prompt, in which the first attack prompt corresponds to an attack prompt having the evaluation score higher than the evaluation score of the second attack prompt;
a library storage unit configured to group the seed, the first attack prompt, the second attack prompt, the first reaction, the second reaction, a difference between the first evaluation score and the second evaluation score, and the strategy as one set to store the one set in a library of the server system;
a reaction network generation unit configured to generate a reaction network including a plurality of reaction nodes serving as nodes for the second reactions having the evaluation scores lower than the evaluation scores of the first reactions, respectively; and
a strategy network generation unit configured to generate a strategy network including a plurality of strategy nodes serving as nodes for the strategies, respectively.

7. A non-transitory computer-readable storage medium storing computer-executable instructions that, when executed by a server system including at least one processor and at least one memory, cause the server system to perform operations for implementing a method of generating a reaction-strategy network for red teaming, wherein the operations comprise:
an attack prompt generation step of generating an attack prompt by inputting a seed including a generation request for the attack prompt into an attack prompt generation module;
a reaction derivation step of deriving a reaction by inputting the attack prompt into a target LLM;
an evaluation score derivation step of deriving an evaluation score for the reaction by inputting the corresponding reaction into an evaluation module;
a strategy derivation step of selecting a strategy pair including first and second attack prompts, first and second reactions, and first and second evaluation scores and having the different evaluation scores for the same seed, and inputting the seed, the first attack prompt, the second attack prompt, the first reaction, the second reaction, the first evaluation score, and the second evaluation score into a strategy derivation module to derive a strategy corresponding to the first attack prompt, in which the first attack prompt corresponds to an attack prompt having the evaluation score higher than the evaluation score of the second attack prompt;
a library storage step of grouping the seed, the first attack prompt, the second attack prompt, the first reaction, the second reaction, a difference between the first evaluation score and the second evaluation score, and the strategy as one set to store the one set in a library of the server system;
a reaction network generation step of generating a reaction network including a plurality of reaction nodes serving as nodes for the second reactions having the evaluation scores lower than the evaluation scores of the first reactions, respectively; and
a strategy network generation step of generating a strategy network including a plurality of strategy nodes serving as nodes for the strategies, respectively.
